(19) United States
(12) Patent Application Publication
(10) Pub. No.: US 2026/0262666 A1
(43) Pub. Date: Sep. 10, 2026

(54) FORMULATION OF HIGH PROTEIN FERMENTED DAIRY PRODUCT WITH INCREASED CONDENSED MILK CONTENT

(71) Applicant: Compagnie Gervais Danone, Paris (FR)

(72) Inventors: Pradeep SURIYA NARAYANAN, Toronto (CA); Sonia CARROLA, Denver, CO (US)

(21) Appl. No.: 19/559,643

(22) Filed: Mar. 6, 2026

Related U.S. Application Data
(60) Provisional application No. 63/768,721, filed on Mar. 7, 2025.

(51) Int. Cl. A23C 9/127; A23C 9/12

(52) U.S. Cl. CPC A23C 9/1275; A23C 9/1206; A23C 2220/10; A23C 2220/20; C12Y 302/01108

(57) ABSTRACT

The disclosure provides a process for making a fermented dairy product comprising the steps of (i) combining at least 30% of concentrated skim milk with cream and skim milk to produce a dairy base containing from about 5 to about 8.5 wt % protein, and (ii) inoculating the dairy base with a yogurt culture and fermenting to produce a fermented dairy product. The disclosure also provides for fermented dairy products obtained from the process.

### CROSS-REFERENCE TO RELATED APPLICATION

This application claims priority of U.S. Provisional Application No. 63/768,721, filed on Mar. 7, 2025, which is hereby incorporated by reference in its entirety.

### BACKGROUND

High protein fermented dairy products, such as strained yogurts, are products obtained by a process involving fermentation of a dairy material with lactic acid bacteria and a subsequent separation step that produces a concentrated strained fermented dairy product and an acid whey by-product.

A standard process calls for an initial starting material of milk having about 3.3% total nitrogen (protein) and about 4.0% milk sugar (lactose), which is fermented and separated/concentrated to produce a strained fermented dairy product having about 10.0% total nitrogen (protein) and about 4.0% milk sugar (lactose) and a whey by-product comprising about 0.4% total nitrogen (protein) and about 4.0% milk sugar. The separation step can be performed notably by centrifugation.

This step is usually performed after the fermentation step which, depending on the culture used, can alter the separation. For example, the separation efficiency can be reduced in presence of Bifidobacteria in the culture mix. In the presence of this type of culture, the person skilled in the art is therefore discouraged from using this method.

This technology produces a liquid phase also called whey which is a by-product of the process and in some cases difficult to recover and valorize.

Ultrafiltered milk (UF) is also often used in high protein fermented dairy products manufacturing. The ultrafiltration process removes some of the water and lactose from the milk, concentrating the proteins. By removing some of the lactose, ultrafiltered milk can be used to produce yogurt that is lower in lactose, making it more suitable for people with lactose intolerance. In the US, the Food and Drug Administration (FDA) has specific standards of identity for yogurt, which historically did not include provisions for the use of UF milk. Therefore, there are challenges to use of UF milk to produce high protein yogurts.

### SUMMARY OF THE DISCLOSURE

Some consumers all over the world would appreciate access to yogurt having high protein content and with a higher lactose and mineral content relative to the protein level. In particular, some consumers would appreciate additionally to access to yogurt contained at least a bifidobacteria that is well known to have gut health effects.

However, surprisingly with the complete combined process developed and described in this disclosure, whose parameters have been clearly defined, the obtained fermented dairy product have excellent organoleptic properties (high protein content, weak post acidification, good lactic acid bacteria count until the end of the shelf life, a creamy, low acid and low astringent taste and a good texture).

The present disclosure follows from the unexpected finding by the inventors that that the use of condensed skim milk (CSM) in the dairy base as a major ingredient providing protein, lactose and minerals and resulting in a higher lactose and mineral content relative to protein level (compared to other products in the market) allows to produce a fermented dairy product having excellent organoleptic properties, in particular a moderate lactic acid production.

The disclosure addresses at least one of the issues and/or needs mentioned above with a process for making a fermented dairy product comprising the steps of:
Step 1) combining at least 30% of concentrated skim milk with cream and skim milk to produce a dairy base containing from about 5 to about 8.5 wt % protein, in particular from about 6 to about 8 wt % protein and even more particularly from about 7 to about 7.5 wt % protein, and
Step 2) inoculating the dairy base with a yogurt culture and fermenting to produce a fermented dairy product.

### DETAILED DESCRIPTION OF THE DISCLOSURE

As used herein, the term “x % (w/w)” or “x % w/w” is equivalent to “x g per 100 g”. Unless indicated otherwise, all % values shall be taken to indicate x % w/w.

As used herein, the term “x % (v/v)” or “x % v/v” is equivalent to “x ml per 100 ml”.

In the context of the disclosure, the term “at least” also includes the starting point of the open range. For example, an amount of “at least 95.00% w/w” means any amount equal to 95.00 percentage by weight or above.

In the context of the disclosure, the term “about” defines a range of plus or minus 10% of the cited value. For example, an amount of “about 20 weights %” means any amount within the range of 18.00 to 22.00 weight %.

As used herein, the adjective “dairy” shall be taken to mean a composition or product which comprises or consists of mammalian milk matter, i.e. the lacteal secretion obtainable by milking.

As used herein, the terms “dairy composition”, “milk-based composition” or “dairy product” shall be taken to mean a product or composition comprising essentially of or consisting of milk or milk components and optionally further ingredients.

As used herein, the term “added sugar” shall refer to sugars that are added during the production or processing of foods (e.g. plant matter processed to provide a vegetal base) as opposed to sugars naturally occurring in said foods. Added sugars include sugars (free, mono- and disaccharides), sugars from syrups and honey, and sugars from concentrated fruit or vegetable juices that are more than what would be expected from the same volume of 100 percent fruit or vegetable juice of the same type.

As used herein, the term “fermented dairy” shall be taken to mean a product or composition that is the product of the acidifying fermentation of a milk-based composition by a starter culture of fermenting microorganisms, in particular bacteria, preferably lactic acid bacteria. As used herein the term “fermented milk” shall be taken to mean a product or composition derived from milk by the acidifying action of at least one lactic acid bacterium. Accordingly, as used herein a fermented dairy product can thus be a fermented milk, such as a yoghurt (e.g. a set, stirred or drink yogurt), or a fresh cheese such as a white cheese or a “petit-Suisse”.

The terms “fermented milk” and “yogurt” or “yoghurt” are given their usual meanings in the field of the dairy industry, that is, products suitable for human consumption and originating from acidifying lactic fermentation of a milk substrate. These products can contain secondary ingredients such as fruits, vegetables, sugar, etc. The expression “fermented milk” may be used to refer to fermented milks other than yogurts e.g. “Kefir”, “Kumtss”, “Lassi”, “Dahi”, “Leben”, “Filmjolk”, “Villi”, “Acidophilus milk”.

The term “yogurt” or “yoghurt” as used herein shall be taken to mean fermented milk obtained by the acidifying lactic fermentation of specific thermophilic lactic acid bacteria such as Lactobacillus bulgaricus (also referred as Lactobacillus delbrueckii subsp. bulgaricus) and Streptococcus thermophilus (also referred to as Streptococcus salivarius subsp. thermophilus), which must be viable in the finished product at a minimum CFU. In certain countries, regulations allow the addition of further lactic acid bacteria to yoghurt such as but not limited to strains of Bifidobacterium and/or Lactobacillus acidophilus and/or Lactobacillus casei. These additional lactic acid bacteria strains are intended to impart various properties to the finished product, such as that of providing organoleptic qualities, favoring equilibrium of intestinal flora or modulating the immune system.

As used herein, the term “spoonable” shall be taken to mean a solid or semi-solid that may be consumed by means of a spoon or other utensil.

As used herein, the term “drinkable” shall be taken to mean a liquid-type consistency that can be easily consumed by drinking directly from a bottle or carton, which does not require a spoon or other utensil.

As used herein, the term “fermentation” shall be taken to mean the metabolism of a substance by microorganisms, e.g. bacteria, yeasts, or other microorganisms.

As used herein, the term “viable” when used in reference to a micro-organism shall be taken to mean a metabolically and physiologically active micro-organism. Means for the detection of viability in micro-organisms are known in the art and include plate count and flow cytometry-based methods.

As used herein, the term “cfu” or “CFU” shall be taken to be an abbreviation of the term “colony forming unit”.

As used herein the term “CNCM I-” followed by a 4 digit number shall be taken to refer to a strain deposited at the Collection Nationale de Cultures de Microorganismes (CNCM), Institut Pasteur, 25-28 rue du Docteur Roux, 75724 Paris Cedex 15, France, under the Budapest Treaty with an accession number corresponding to said 4 digit number. The deposits were made in accordance with the Budapest Treaty on the International Recognition of the Deposit of Microorganisms for the Purposes of Patent Procedure, as provided therein the applicant requests that a sample of the deposited micro-organisms only be made available to an independent expert, until the date on which the patent may be granted.

As used herein the term “fat content” of a composition corresponds to the weight of the fat components present in the composition relatively to the total weight of the composition. The fat content is expressed as a weight percentage. The fat content can be measured by the Weibull-Berntrop gravimetric method described in the standard NF ISO 8262-3. Usually, the fat content is known based on the fat content of the ingredients used to prepare the composition, and the fat content of the product is calculated based on these data.

As used herein the term “protein content” of a composition corresponds to the weight of the proteins present in the composition relative to the total weight of the composition. The protein content is expressed as a weight percentage. The protein content may be measured by Kjeldahl analysis (NF EN ISO 8968-1) as the reference method for the determination of the protein content of dairy products based on measurement of total nitrogen. Nitrogen is multiplied by a factor, typically 6.38, to express the results as total protein. The method is described in both AOAC Method 991.20 (1) and International Dairy Federation Standard (IDF) 20B: 1993.

Usually, the total protein content is known for all the ingredients used to prepare the product, and total protein content is calculated from these data.

As used herein the term “dry matter” of a product corresponds to the weight of non-volatile components present in the product relatively to the total weight of the product. The dry matter is expressed as a weight percentage. The “non-volatile components” correspond to the solids that remain after an evaporation step of the product at 103-105° C. The dry matter can be measured by the method disclosed in NF V04 370 comprising a heating step at 102° C. Usually the dry matter is known for all the ingredients used to prepare the product, and dry matter is calculated from these data.

The term “concentrated milk” or “condensed milk” as used herein corresponds to the liquid food obtained by partial removal of water from milk (eCFR: 21 CFR 131.115). The name of the food is “concentrated milk” or alternatively “condensed milk”. By equivalence, the term “concentrated skim milk” or “condensed skim milk” as used herein corresponds to the liquid food obtained by partial removal of water from skim milk.

### Process

Details of materials and process steps are provided below:

### Step 1)

Step 1) is a step of combining at least 30% of concentrated skim milk with cream and skim milk to produce a dairy base containing from about 5 to about 8.5 wt % protein, from about 5 to about 8.5 wt % protein, in particular from about 6 to about 8 wt % protein and even more particularly from about 7 to about 7.5 wt % protein.

Step 1) involves an initial step a) of providing a concentrated skim milk comprising proteins, lactose and minerals wherein the concentrated skim milk contains from about 9 to about 14 wt % protein, in particular from about 11 to about 12 wt % protein, and even more particularly from about 11 to about 11.5 wt % protein. The concentrated skim milk can have a lactose content of about 14 to 21 wt %, in particular from about 12 to about 20 wt % and even more particularly from about 14 to 18 wt %. The concentrated skim milk can have a ratio by weight of protein to lactose of from 1:1 to 3:7. The concentrated skim milk can be obtained by a process of evaporation of the water contained in the initial milk or by a process of separation of fats to obtain skim milk, then concentrated by a low heat process (for example at 72° C., during 16 seconds). Preferably, the condensed skim milk is in a liquid form.

Step 1) involves a mixing step b), wherein skim milk and cream is added to the concentrated milk. This mixing step typically involves the addition of skim milk in a liquid form. The liquid skim milk can have a protein content from 3 to 4 wt % and a lactose content from 3 to 5 wt %. The liquid skim milk is prepared by a known process in the art. Preferably the skim milk is a not a reduced-lactose skim milk. This mixing step typically involves the addition of cream in a liquid form. The cream can have a fat content of from 20 to 50 wt %, in particular from 23 to 40 wt %. The cream is prepared by a known process in the art. The mixing step b) can further comprise adding at least 30 wt % of concentrated skim milk. The addition can be of at least 35 wt % or be at least 40 wt % or be at least 50 wt %. Preferably, the condensed skim milk can deliver from about 50 to about 90% of the proteins of the dairy base. The mixing step b) can further comprise adding from about 10% to about 65 wt % of skim milk and from about 0.1 to about 10 wt % of cream.

The mixing step provides a dairy base containing from about 5 to about 8.5 wt % protein, in particular from about 6 to about 8 wt % protein, more particularly from about 7 to about 7.5 wt % protein and even more preferably 7.5 wt % proteins. The mixing step provides a dairy base containing from about 6 to about 9 wt % lactose, in particular from about 6.5 to about 8.5 wt % lactose, more particularly from about 7 to about 8 wt % lactose and even more preferably 7.7 wt % lactose. The dairy base can have a ratio by weight of protein to lactose of from 3:2 to 2:3, and in particular a ratio of 1:1.

### Step 2)

Step 2) is a step of inoculating a dairy base with a yogurt culture and fermenting to produce a fermented dairy product.

In a particular embodiment, step 2) involves the addition of lactase enzyme and is carried out in various orders. In an embodiment, the lactase enzyme and the yogurt culture are added simultaneously or one after the other. Advantageously, the lactase is added before or along with the culture of bacteria. The lactase enzyme can be selected from β-galactosidase derived from various yeast or bacterium, in particular selected among Ha-lactase™ 5200, Maxilact®Lgi 5000 or Nola FIT 5500. The lactase enzyme can be added in an amount of 0.02% to 0.05%, in particular 0.30% to 0.45%.

Step 2) involves a fermentation step with a yogurt culture. In this step, the dairy base obtained in step 1) is inoculated with lactic acid bacteria and the mixture is then allowed to ferment at a temperature between 35° C. and 44° C. notably between 35.5 and 36.7° C. for 8 to 13 hours, preferably for 9 to 11 hours. The breaking pH can be more particularly from 3.5 to 5.0, even more particularly from 4.00 to 5.00, and still more particularly from higher than 4.50 to 4.80. Appropriate lactic acid bacteria are known by those of skill in the art. The lactic acid bacteria may be introduced in any appropriate form, for example, in a spray-dried form, a freeze-dried form or in a frozen form, preferably in a liquid form. The introduction of the lactic acid bacteria in the dairy material is also referred to as an inoculation.

Lactic acid bacteria may be referred to herein as ferments or cultures or starters. Examples of lactic acid bacteria that can be used include:
Lactobacilli, for example, Lactobacillus acidophilus, Lactobacillus casei, Lactobacillus paracasei, Lactobacillus plantarum, Lactobacillus reuteri, Lactobacillus johnsonii, Lactobacillus helveticus, Lactobacillus brevis, Lactobacillus rhamnosus,
Streptococci, for example, Streptococcus thermophilus, Streptococcus cremoris,
Bifidobacteria, for example, Bifidobacterium bifidum, Bifidobacterium longum, Bifidobacterium breve, Bifidobacterium animalis,
Lactococci, for example, Lactococcus lactis subsp. lactis, Lactococcus lactis subsp. cremoris,
Propionibacterium such as, Propionibacterium freudenreichii, Propionibacterium freudenreichii ssp shermanii, Propionibacterium acidipropionici, Propionibacterium thoenii,
and mixtures and/or combinations thereof.

The lactic acid bacteria may comprise, may essentially consist of, or may consist of, Lactobacillus delbrueckii ssp. bulgaricus (i.e. Lactobacillus bulgaricus) and Streptococcus salivarius ssp. thermophilus (i.e. Streptococcus thermophilus) bacteria. The lactic acid bacteria used in the disclosure typically comprise an association of Streptococcus thermophilus and Lactobacillus bulgaricus bacteria. This association is known and often referred to as a yogurt symbiosis or yogurt culture. Examples include culture YoMix® 495 marketed by Dupont.

More preferred lactic acid bacteria to be used in the disclosure are selected from:
Lactobacillus delbrueckii subsp. bulgaricus deposited under the number CNCM I-1632 or Lactobacillus delbrueckii subsp. bulgaricus deposited under the number CNCM I-1519, or Lactobacillus delbrueckii subsp. bulgaricus deposited under the number CNCM I-2787,
Lactobacillus acidophilus deposited under the number CNCM I-2273,
Lactobacillus rhamnosus deposited under the number CNCM I-4993,
Streptococcus thermophilus deposited under the number CNCM I-1630, or Streptococcus thermophilus deposited under the number CNCM I-4992 or Streptococcus thermophilus deposited under the number CNCM I-5030,
Lactococcus lactis subsp. lactis deposited under the number CNCM I-1631,
Lactococcus lactis subsp. cremoris deposited under the number CNCM I-3558,
Bifidobacterium animalis subsp. lactis deposited under the number CNCM I-2494, and combinations thereof.

The lactic acid bacteria used in the disclosure typically comprise an association of Streptococcus thermophilus CNCM I-1630, Lactobacillus delbrueckii subsp. bulgaricus CNCM I-1632, Lactobacillus delbrueckii subsp. bulgaricus CNCM I-1519 and Bifidobacterium animalis subsp. lactis CNCM I-2494.

In an embodiment, fermented dairy product of the disclosure comprises at least 106, preferably at least 10⁷, more preferably at least 108 colony forming unit (CFU) of Bifidobacteria per gram of the fermented dairy product.

In an embodiment, fermented dairy product of the disclosure comprises at least 106, preferably at least 10⁷, more preferably at least 108 colony forming unit (CFU) of Lactobacillus delbrueckii subsp. bulgaricus per gram of the fermented dairy product.

In an embodiment, fermented dairy product of the disclosure comprises at least 106, preferably at least 10⁷, more preferably at least 108 colony forming unit (CFU) of Streptococcus thermophilus per gram of the fermented dairy product.

In an embodiment, fermented dairy product of the disclosure comprises at least 106, preferably at least 10⁷, more preferably at least 108 colony forming unit (CFU) of Lactobacillus delbrueckii subsp. bulgaricus per gram of the fermented dairy product.

Surprisingly, it was observed that in step 2), despite the high protein level in the dairy base before fermentation, the amount of lactic acid at the final pH was comparable to a strained yogurt. It was unexpected, based on the fact that the proteins have a high buffer capacity ((Salaün, Mietton, & Gaucheron, 2005) [Yoghurt milk bases with high protein contents have high buffering capacities, resulting in increased fermentation times to obtain a predetermined pH-value]).

High protein fermented dairy product with high sensory qualities can be obtained by using a high content of condensed skim milk in the dairy base prior to fermentation.

The fermented dairy product obtained by the process according to the disclosure is characterized by a protein content in a range from about 5% wt to about 8.5 wt %, in particular from about 6% to about 8% wt.

The fermented dairy product obtained by the process according to the disclosure is characterized by a calcium content in a range from about 200 to about 300 ppm, in particular from about 230 to about 270 ppm (by weight).

The fermented dairy product obtained by the process according to the disclosure is characterized by a phosphorus content in a range from about 150 to about 250 ppm, in particular from about 180 to about 220 ppm (by weight).

The fermented dairy product obtained by the process according to the disclosure is characterized by a potassium content in a range from about 210 to about 310 ppm, in particular from about 240 to about 280 ppm (by weight).

### Other Optional Steps

The process may comprise at least one heat treatment step, for example during step 1). It typically involves heat treating the skim milk before or after the mixing step or the dairy base before step 2). Such heat treatments are known by those of skill in the art as, for example, pasteurization or sterilization. Heat treatments are used to eliminate micro-organism contaminants such as, for example, bacteria. Heat treatments may be performed in conventional heat exchangers, such as tube or plate heat exchangers. The heat treatment may, for example, be performed at a temperature of from 80° C. to 99° C., and more particularly from 85° C. to 95° C. for, for example, from 1 minute to 15 minutes.

The process may further comprise a homogenization step before or after the heat treatment step, more particularly, in particular a two-stages homogenization with a pressure of about 2500 psi in the first stage and a pressure of about 800 psi in a second stage.

After heat treatment, the dairy base is typically cooled down to a fermentation temperature. The process may comprise at least one cooling step after the step 2).

The process of the disclosure may comprise a step wherein the fermented dairy product undergoes a smoothing step. Such steps typically involve some agitation and/or shear, and are known by those of skill in the art.

The process does not comprise a separation step resulting in a whey by-product.

The process does not comprise an ultrafiltration step for treating the milk, in particular the skim milk. In other words, the skim milk is not a reduced-lactose skim milk. The term reduced-lactose skim milk corresponds to a skim milk having less lactose (% wt) than in the initial skim milk.

The process does not comprise a step of addition of sugar. The term “addition of sugar” or “added sugar” shall refer to sugars that are added during the production or processing of foods (e.g. plant matter processed to provide a vegetal base) as opposed to sugars naturally occurring in said foods. Added sugars include sugars (free, mono- and disaccharides), sugars from syrups and honey, and sugars from concentrated fruit or vegetable juices that are more than what would be expected from the same volume of 100 percent fruit or vegetable juice of the same type.

### Intermediate Preparation

Intermediate preparations are known by those skilled in the art. They are typically used to modify the taste, the mouthfeel and/or texture of a dairy composition. They typically comprise sweetening agents, flavors, color modifiers, stabilizers, regulators, fibers, cereals and/or fruit. Intermediate preparations are for example slurries or fruit preparations.

Examples of fruits include for example strawberry, peach, apricot, mango, apple, pear, raspberry, blueberry, blackberry, passion, cherry, and mixtures or associations thereof.

Examples of fibers include for example galacto-oligosaccharides (GOS), fructo-oligosaccharides (FOS) and/or combinations thereof. As used herein, “galacto-oligosaccharides” (or “GOS”) may refer to β-galacto-oligosaccharides, α-galacto-oligosaccharides and galactan. Preferably, GOS are β-galacto-oligosaccharides. Preferably, GOS comprise galacto-oligosaccharides with β(1,4), β(1,3) and/or β(1,6) glycosidic bonds and a terminal glucose. For example, GOS suitable for use in the disclosure are commercially available under the trade name VIVINAL®GOS, VINALOGOS (Friesland Campina Ingredients), Bi2muno (Clasado), Cup-oligo (Nissin Sugar) and Oligomate55 (Yakult). As used herein, “fructo-oligosaccharides” (or “FOS”) may refer to oligosaccharides comprising β-linked fructose units, which are preferably linked by β(2,1) and/or β(2,6) glycosidic linkages. Preferably, FOS contain a terminal β(2,1) glycosidic linked glucose. Preferably, FOS contain at least 7 β-linked fructose units. In a preferred embodiment, inulin is used. Inulin is a type of FOS wherein at least 75% of the glycosidic linkages are β(2,1) linkages. For example, FOS suitable for use in the disclosure are commercially available under the trade name Orafti®HP and Orafti®HPX (Beneo), FIBRULOSE® and FIBRULINE® (Cosucra) and FRUTAFIT® and FRUTALOSE® (Sensus).

The fermented dairy product is recovered and optionally processed for example to a further food form and/or mixed with further intermediate preparations.

In a particular embodiment the intermediate is substantially free of added sugar, for example substantially free of sugar, sucrose, fructose syrup, sugarcane syrup, high fructose corn syrup or the like. Lactase enzyme included in formula will convert this increased lactose content into galactose and glucose providing an increased sweetness without any added sugar.

In one embodiment, the fermented dairy product is processed for example with other nutrients such as but not limited to vitamins (vitamin D, C . . . ), minerals, trace elements or other micronutrients.

In one embodiment, the fermented dairy product contains for example an amount of 1-5 wt %, in particular 2-4 wt % of a soluble fiber.

### EXAMPLES

### Example 1: Standard Manufacture of a Strained Fermented Dairy Product

A standard strained process as described in a Danone patent application WO2017112883 has been realized with and without the presence of Bifidobacterium animalis subsp. lactis.

### Results:

The strained fermented dairy product has 10.0% by weight of protein and 4.0% by weight of milk carbohydrate comprising lactose. The ratio between protein and carbohydrate (lactose) is about 2.5. It was noted that the protein concentration (the rate of protein enrichment=yield in %) in the step of separation is decreased when the dairy base is inoculated with Bifidobacterium animalis subsp. lactis (30.58% compared to approximately between 32-36.5%). These fluctuations in milk protein content and indirectly in cost cannot be accepted.

### Example 2: Manufacture of a Fermented Dairy Product

High protein fermented dairy product A was prepared.

The process comprising at least the following steps:
A mixing step of condensed milk, cream, skim milk, vitamin D and MPI (milk protein isolate) as in the table 1, to produce a dairy base having a protein content of 7-7.5%,
a pre-heat treatment step at a temperature of from 68 to 72° C. of the dairy base,
a homogenization step in particular a two-stages homogenization with a pressure of about 2500 psi in the first stage and a pressure of about 800 psi in a second stage,
a step of pasteurizing of the dairy base at a temperature between 81 to 99° C. during about 30 seconds to about 400 seconds,
a step of cooling at a temperature between 35° C. and 44° C.,
a fermentation step with at least Streptococcus thermophilus, Lactobacillus delbrueckii subsp. bulgaricus and Bifidobacterium animalis subsp. lactis CNCM I- 2494 and the lactase NOLA Fit 5500 at a temperature of from 35° C. and 44° C., during 8 to 11 hours,
a cooling step to a temperature of from 15.5 to 21° C. and a storage at 4° C.

TABLE 1

| | | | True |
|---|---|---|---|
| Product A | (%) | TS % | protein % |
| SKIM MILK | 60.560000% | 8.932000% | 3.134000% |
| CONDENSED MILK | 32.630914% | 32.460000% | 11.350000% |
| CREAM | 4.694269% | 47.642000% | 1.732000% |
| MPI | 2.000000% | 95.500000% | 82.000000% |
| VITAMIN D | 0.004817% | 95.000000% | 0.000000% |
| β-galactosidase | 0.040000% | 0.000000% | 0.000000% |
| ENZYME | | | |
| CULTURE | 0.070000% | 0.000000% | 0.000000% |
| TOTALS | 100.000000% | 19.6602% | 7.1500% |
| The dairy base: | | | |

The process described allows to obtain a high protein fermented dairy product having around 2.2% fat and around 7.15% proteins meeting cost and sensory targets, with no supply constraints on ingredients.

### A) Titratable Acidity Over Shelf Life of Products Produced by the Process

Titratable acidity (TA) is a measure of the total acidity in a product, expressed as the amount of acid present. It's determined by titrating the product with a base (like sodium hydroxide, NaOH) until the acids in the product are neutralized. The result gives an idea of the overall acidity level, which is important for the taste, stability, and preservation of the product.

4 types of products have been produced with the process described herein: i) Activia strawberry comprising at least 8% of fruit preparation ii) Activia vanilla comprising at least 8% of fruit preparation iii) Activia mixed berry comprising at least 8% of fruit preparation, iv) Activia peach mango comprising at least 8% of fruit preparation.

The titratable acidity was measured over the shelf life of the product by an automated titrator using an acid-base titration with a standardized sodium hydroxide solution at 20° C.

TABLE

| | Titratable acidity |
|---|---|
| Type of products | at different time |
| Activia | Day 14- 1.290% |
| Strawberry | Day 35- 1.290% |
| | Day 42 - 1.411% |
| | Day 49 - 1.309% |
| | Day 56 - 1.339% |
| Activia | Day 14- 1.272% |
| Vanilla | Day 35- 1.264% |
| | Day 42 - 1.315% |
| | Day 49 - 1.278% |
| | Day 56 - 1.306% |
| Activia | Day 14- 1.272% |
| Mixed Berry | Day 42 - 1.317% |
| | Day 49 - 1.312% |
| | Day 56 - 1.340% |
| Activia | Day 14- 1.271% |
| Peach Mango | Day 35- 1.262% |
| | Day 42 - 1.323% |
| | Day 49 - 1.276% |
| | Day 56 - 1.326% |

The titratable acidity of the 4 products with fruit preparation started at 1.27%-1.29% at the beginning of shelf life and ended between 1.30%-1.35% at the end of shelf life. This is within the typical range for yogurts, which is 0.69%-1.81% (Matela, K. S., Pillai, M. K., & Thamae, T. (2019). Evaluation of pH, titratable acidity, syneresis and sensory profiles of some yoghurt samples from the Kingdom of Lesotho. Food Research, 3 (6), 693-697)

### B) Consumer Tests

A blind, sequential monadic central location test was performed with 240 participants to validate consumer acceptance of the product.

Flavors scored 8.1 and 8.0, respectively, on a 9 pt scale for overall liking. Compared against a database of 74 yogurt products using non-cane sugar sweeteners, this product ranked in the top 1% of overall liking.

A Just-About-Right (JAR) test have been performed. A Just-About-Right (JAR) test is a sensory evaluation tool used to measure the intensity of specific attributes in a product, such as sweetness, texture etc. The goal is to determine the optimal level of these attributes to maximize consumer satisfaction. In a JAR test, participants rate each attribute on a scale that typically ranges from “much too little” to “much too much,” with “just about right” in the middle. This helps researchers understand whether a product's attributes are at the ideal level or need adjustmentJAR tests are commonly used in food product development to fine-tune formulations and improve overall consumer acceptance.

In a Just-About-Right (JAR) test, where standard was for greater than 65% of respondents selecting JAR for an attribute, both flavors received between 77-85% JAR for attributes of sweetness, tartness, and sweet/tart balance. Both flavors of product scored above 87% JAR for texture attributes of creaminess and smoothness.

### C) Cell Counts

There is no impact of the process on the yoghurt symbiosis and the bifidobacteria population. They maintain the normal growth and survival. LINK Excel.Sheet.12 “C:\\Users\\Suriyapr\\AppData\\Local\\Microsoft\\Olk\\Attachments\\ooa-e2c23872-9f9c-422f-a9e3-15490630e4e2\\b933201929b303c1caf7064a9cc85765519eaf2b0fd62a5ab2a1eb01c53c834 a\\ACP Trifecta Culture Counts.xlsx” “Industrial Trial Data!R2C1: R5C5” \a \f 5 \h \* MERGEFORMAT

| | CFU/g | | | Production |
|---|---|---|---|---|
| Strains | Minimum | CFU/g | Test Date | date |
| Bifidobacterium lactis | 3.40E+07 | 2.30E+08 | Jan. 11, 2024 | Oct. 31, 2023 |
| S thermophilus + | 1.23E+07 | 6.76E+08 | Jan. 11, 2024 | Oct. 31, 2023 |
| L bulgaricus | | | | |
| L lactis | 1.0 E+03 | 1.30E+06 | Jan. 29, 2024 | Oct. 31, 2023 |

1. A process for making a fermented dairy product comprising the steps of:
i) combining at least 30% of concentrated skim milk with cream and skim milk to produce a dairy base containing from about 5 to about 8.5 wt % protein, in particular from about 6 to about 8 wt % protein and even more particularly from about 7 to about 7.5 wt % protein, and
ii) inoculating the dairy base with a yogurt culture and fermenting to produce a fermented dairy product.

2. The method of claim 1, wherein the concentrated skim milk contains from about 9 to about 14 wt % protein, from about 11 to about 12 wt % protein, or from about 11 to about 11.5 wt % protein.

3. The method of claim 1, wherein the concentrated skim milk has a lactose content of about 14 to 21 wt %, or from about 12 to about 20 wt %, or from about 11 to 18 wt %.

4. The method of claim 1, wherein the concentrated skim milk has a ratio by weight of protein to lactose of from 1:1 to 3:7.

5. The method of claim 1, wherein the concentrated skim milk is in a liquid form.

6. The method of claim 1, wherein the mixing step is performed with at least 30% of concentrated skim milk, at least 35% of concentrated skim milk, at least 40% of concentrated skim milk, or at least 50% of concentrated skim milk.

7. The method of claim 1, wherein the dairy base has a ratio by weight of protein to lactose of from 3:2 to 2:3, or 1:1.

8. The method of claim 1, wherein the yogurt culture contains at least a lactic acid bacteria selected from S. thermophilus sp, Lactobacillus sp., Bifidobacterium sp. and combinations thereof.

9. The method of claim 1, wherein the yogurt culture contains at least Streptococcus thermophilus CNCM I-1630, Lactobacillus delbrueckii subsp. bulgaricus CNCM I-1632, Lactobacillus delbrueckii subsp. bulgaricus CNCM I-1519 and Bifidobacterium animalis subsp. lactis CNCM I-2494.

10. The method of claim 1, wherein the inoculation step is performed with the addition of a lactase enzyme.

11. The method of claim 1, wherein the lactase enzyme and the yogurt culture are added simultaneously or one after the other.

12. The method of claim 1, wherein the lactase enzyme is selected from Ha-lactase™ 5200, Maxilact®Lgi 5000 or Nola FIT 5500.

13. The method of claim 1, wherein the lactase enzyme is added in an amount of 0.02% to 0.05%, or 0.35% to 0.45%.

14. A fermented dairy product made by the process of claim 1.
